(19) United States
(12) Patent Application Publication
(10) Pub. No.: US 2014/0375561 A1
(43) Pub. Date: Dec. 25, 2014

(54) MOBILE DEVICE AND REMOTE CONTROL METHOD

(71) Applicant: HON HAI PRECISION INDUSTRY CO., LTD., New Taipei (TW)

(72) Inventors: MING-CHUAN KAO, New Taipei (TW); CHENG-JUI YU, New Taipei (TW)

(21) Appl. No.: 14/308,860

(22) Filed: Jun. 19, 2014

(30) Foreign Application Priority Data
Jun. 21, 2013 (CN) 2013102505928

(51) Int. Cl. G06F 3/038

(52) U.S. Cl. CPC G06F 3/0383
USPC 345/157

(57) ABSTRACT

Method of remote control includes determining a selected virtual key on a user interface provided by the mobile device and acquiring an identification number of the selected virtual key from a storage device of the mobile device. In response to detecting infrared signals sent from a remote controller to an electronic device, the infrared module is controlled to record the infrared signals of one or more keys on the remote controller in sequence. The recorded infrared signals is stored to a queue corresponding to the identification number of the selected virtual key in sequence. Induction delay time corresponding to each of the recorded infrared signals in the queue are set.

### FIELD

Embodiments of the present disclosure relate to remote control technology, and particularly to a mobile device and a remote control method using the mobile device.

### BACKGROUND

A physical key of a remote controller can transmit an infrared signal to an electronic device (e.g., a television). If a specified function of the remote controller needs to be invoked by pressing a plurality of physical keys on the remote controller, a user has to press the physical keys one by one in a short time.

### BRIEF DESCRIPTION OF THE DRAWINGS

Implementations of the present technology will now be described, by way of example only, with reference to the attached figures, wherein:

FIG. 1 illustrates a schematic diagram of one embodiment of a mobile device including a control system.

FIG. 2 illustrates a block diagram of one embodiment of function modules of the control system in the mobile device of FIG. 1.

FIG. 3 illustrates a flowchart of one embodiment of a method of remote control using the mobile device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

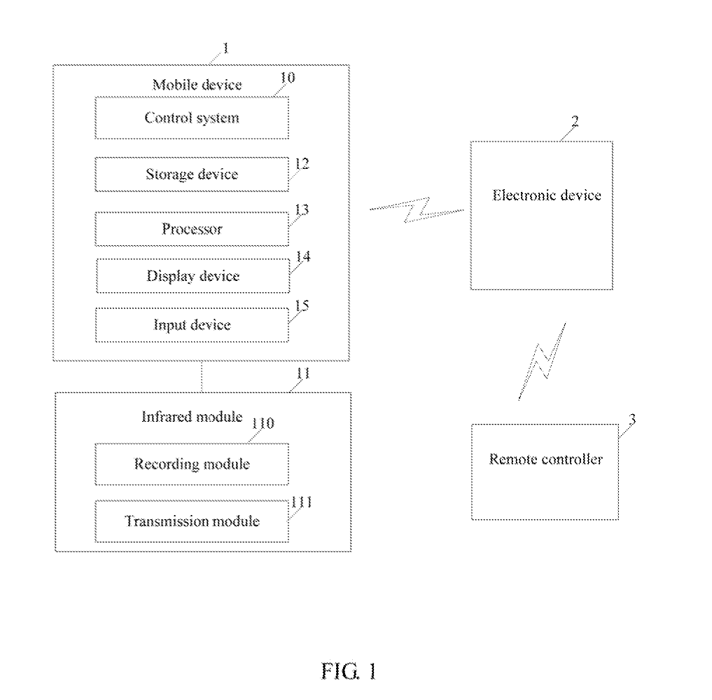

FIG. 1 illustrates a block diagram of one embodiment of a mobile device including a control system. The mobile device 1 is connected to an electronic device 2. The electronic device 2 can be a television or a DVD device. A remote controller 3 can transmit control signals to the electronic device 2 through a wireless connection. The mobile device 1 can be connected to an infrared module 11. In other embodiments, the infrared module 11 can be included in the mobile device 1. The infrared module 11 can include, but is not limited to, a recording module 110, and a transmission module 111. The mobile device 1 can further include a storage device 12, at least one processor 13, a display device 14, and an input device 15. The mobile device 1 can be a tablet computer, a smart phone, a personal digital assistant (PDA), or other suitable mobile device. It should be understood that FIG. 1 illustrates only one example of the mobile device that can include more or fewer components than illustrated, or have a different configuration of the various components in other embodiments.

The control system 10 can remotely control the electronic device 2 using a virtual remote controller displayed on the display device 14. A virtual key of the virtual remote controller can send one or more infrared signals to the electronic device 2.

In at least one embodiment, the storage device 12 can include various types of non-transitory computer-readable storage medium, such as a hard disk, a compact disc, a digital video disc, or a tape drive. The display device 14 can display images and videos, and the input device 15 can be a mouse, a keyboard, a touch panel, or other suitable input device to input computer-readable data.

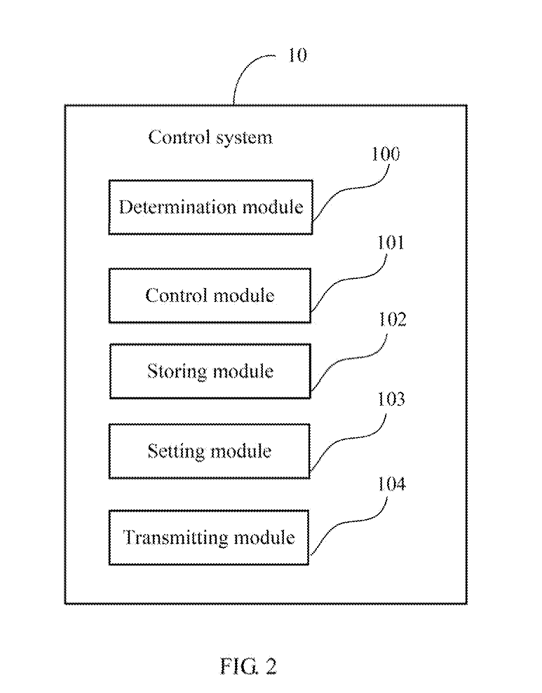

FIG. 2 illustrates a block diagram of one embodiment of function modules of the control system 10. In at least one embodiment, the control system 10 can include a determination module 100, a control module 101, a storing module 102, a setting module 103, and a transmitting module 104. The function modules 100-104 can include computerized codes in the form of one or more programs, which are stored in the storage device 12. The at least one processor 13 executes the computerized codes to provide functions of the function modules 100-104.

A virtual remote controller displayed on the display device 14 can include a plurality of virtual keys, and each of the virtual keys corresponds to an identification number. A user selects a virtual key from the virtual keys. The determination module 100 can determine the selected virtual key, and acquires an identification number of the selected virtual key from the storage device 12 of the mobile device 1.

In at least one embodiment, each virtual key has a plurality of properties. The properties of a virtual key can include, but are not limited to a shape, a size, a name of the virtual key, and a position where the virtual key located on the virtual remote controller. The user can update information of the properties. The determination module 100 can receives the updated information of the properties, then updates the properties according to the updated information.

When one of more keys on the remote controller 3 have been pressed, one or more infrared signals are sent from the remote controller 3 to the electronic device 2. In response to detecting the infrared signals using the infrared module 11, the control module 101 controls the infrared module 11 to record the infrared signals of the one or more keys on the remote controller 3 in sequence using the recording module 110. For example, a signal of switching a television signal to a DVD signal is triggered by pressing “[Input]”, “[Up arrow]”, “[Up arrow]”, “[OK]” of a remote controller 3 in sequence. When the user presses “[Input]”, “[Up arrow]”, “[Up arrow]”, “[OK]” in sequence, the control module 101 controls the infrared module 11 to record an infrared signal of the key “[Input]”, an infrared signal of the key “[Up arrow]”, an infrared signal of the key “[Up arrow]”, and an infrared signal of the key “[OK]” in sequence.

The storing module 102 stores the recorded infrared signals to a queue corresponding to the identification number of the selected virtual key in sequence. In at least one embodiment, each virtual key corresponds to a queue. A recorded infrared signal corresponds to an icon, which can be the same as an icon of a key on the remote controller 3 that transmits the recorded infrared signal.

In some embodiments, icons corresponding to the recorded infrared signals can be displayed on the display device 14. When the recorded infrared signals corresponding to the virtual key needs to be changed, the user can manage icons corresponding to the recorded infrared signals. For example, the user can remove one icon from the icons corresponding to the virtual key to delete a recorded infrared signal corresponding to the removed icon from the queue of the virtual key.

The setting module 103 sets induction delay time corresponding to each of the recorded infrared signals in the queue. In at least one embodiment, the setting module 103 can provide a user interface for the user to set induction delay time corresponding to each of the recorded infrared signals. The induction delay time of the recorded infrared signals can be different or the same.

When the selected virtual key is triggered, the transmitting module 104 transmits the recorded infrared signals in the queue corresponding to the selected virtual key, to the electronic device 2 in sequence using the transmission module 111. For example, when an anterior recorded infrared signal is sent to the electronic device 2, the transmitting module 104 transmits a posterior recorded infrared signal to the electronic device after induction delay time corresponding to the anterior recorded infrared signal.

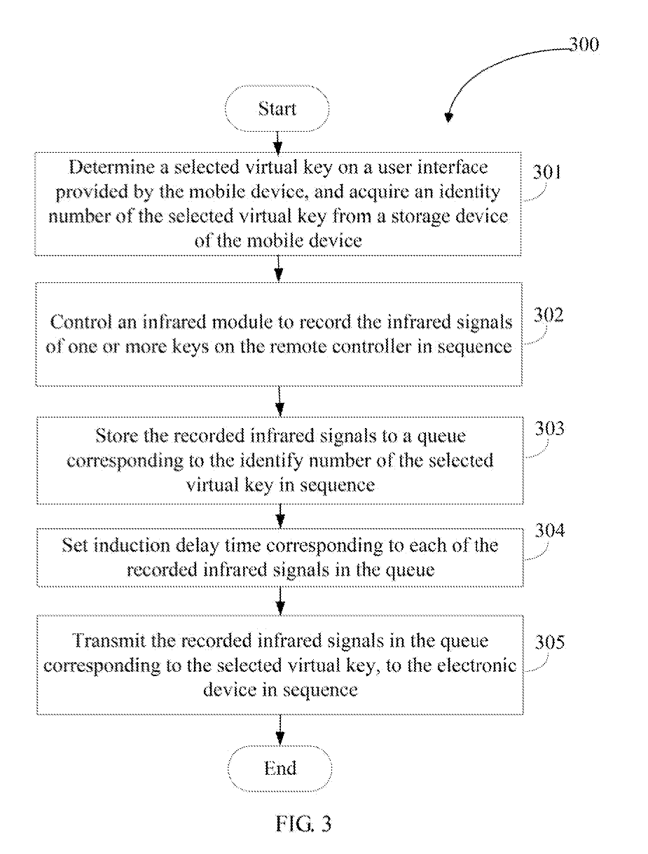

FIG. 3 illustrates a flowchart of an example embodiment of a method of remote control using a mobile device. The method is provided by way of example, as there are a variety of ways to carry out the method. The method described below can be carried out using the configurations illustrated in FIGS. 1, 2, for example, and various elements of FIGS. 1, 2 are referenced in explaining the method. Each block shown in FIG. 3 represents one or more processes, methods, or subroutines carried out in the method. Additionally, the illustrated order of blocks is by example only, and the order of the blocks can change according to the present disclosure. The exemplary method can begin at block 301. Depending on the embodiment, additional steps can be added, others removed, and the ordering of the steps can be changed.

In block 301, A virtual remote controller displayed on a display device of a mobile device can include a plurality of virtual keys, and each of the virtual keys corresponds to an identification number. A user selects a virtual key from the virtual keys. A determination module can determine the selected virtual key, and acquires an identification number of the selected virtual key from a storage device of the mobile device.

In block 302, when one of more keys on a remote controller have been pressed, one or more infrared signals are sent from the remote controller to an electronic device. In response to detecting the infrared signals using an infrared module, a control module controls an infrared module to record the infrared signals of the one or more keys on a remote controller in sequence using a recording module of the infrared module. The infrared module is connected to the mobile device. The remote controller controls the electronic device.

In block 303, a storing module stores the recorded infrared signals to a queue corresponding to the identification number of the selected virtual key in sequence. In at least one embodiment, each virtual key corresponds to a queue. A recorded infrared signal corresponds to an icon, which can be the same as an icon of a key on the remote controller that transmits the recorded infrared signal.

In block 304, a setting module sets induction delay time corresponding to each of the recorded infrared signals in the queue. In at least one embodiment, the setting module can provide a user interface for the user to set induction delay time corresponding to each of the recorded infrared signals. The induction delay times of the recorded infrared signals can be different or the same.

In block 305, when the selected virtual key is triggered, a transmitting module transmits the recorded infrared signals in the queue corresponding to the selected virtual key, to the electronic device in sequence using a transmission module of the infrared module. For example, when an anterior recorded infrared signal is sent to the electronic device, the transmitting module transmits a posterior recorded infrared signal to the electronic device after induction delay time corresponding to the anterior recorded infrared signal.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented remote control method using a mobile device, the mobile device being connected to an infrared module, the method comprising:
determining, at the mobile device, a selected virtual key;
acquiring, at the mobile device, an identification number of the selected virtual key;
in response to detecting infrared signals sent from a remote controller to an electronic device, controlling, at the mobile device, the infrared module to record the infrared signals of one or more keys on the remote controller in sequence;
storing, at the mobile device, the recorded infrared signals to a queue corresponding to the identification number of the selected virtual key in sequence; and
setting, at the mobile device, an induction delay time corresponding to each of the recorded infrared signals in the queue.

2. The method according to claim 1, further comprising:
receiving, at the mobile device, updated information of properties of the selected virtual key.

3. The method according to claim 2, wherein the properties of the selected virtual key comprise a shape, a size, a name of the selected virtual key, and a position where the selected virtual key located on a virtual remote controller.

4. The method according to claim 1, further comprising:
deleting, at the mobile device, one of the recorded infrared signals from the queue when the recorded infrared signal is selected on a display device of the mobile device and a deletion option is triggered.

5. The method according to claim 1, further comprising:
when the selected virtual key is triggered, transmitting, from the mobile device, the recorded infrared signals in the queue corresponding to the selected virtual key, to the electronic device in sequence.

6. The method according to claim 5, further comprising:
when an anterior recorded infrared signal is sent to the electronic device, transmitting, from the mobile device, a posterior recorded infrared signal to the electronic device after induction delay time corresponding to the anterior recorded infrared signal.

7. A mobile device, comprising:
a processor; and
a storage device that stores one or more programs, which when executed by the at least one processor, causes the at least one processor to:
determine a selected virtual key on a user interface provided by the mobile device, and acquire an identification number of the selected virtual key from a storage device of the mobile device;
in response to detecting infrared signals sent from a remote controller to an electronic device, control the infrared module to record the infrared signals of one or more keys on the remote controller in sequence;
store the recorded infrared signals to a queue corresponding to the identification number of the selected virtual key in sequence; and
set induction delay time corresponding to each of the recorded infrared signals in the queue.

8. The mobile device according to claim 7, wherein the at least one processor further receives updated information of properties of the selected virtual key.

9. The mobile device according to claim 8, wherein the properties of the selected virtual key comprise a shape, a size, a name of the selected virtual key, and a position where the selected virtual key located on a virtual remote controller.

10. The mobile device according to claim 7, wherein the at least one processor further deletes one of the recorded infrared signals from the queue when the recorded infrared signal is selected on a display device of the mobile device and a deletion option is triggered.

11. The mobile device according to claim 7, wherein the at least one processor further: when the selected virtual key is triggered, transmits the recorded infrared signals in the queue corresponding to the selected virtual key, to the electronic device in sequence.

12. The mobile device according to claim 11, wherein the at least one processor further: when an anterior recorded infrared signal is sent to the electronic device, transmits a posterior recorded infrared signal to the electronic device after induction delay time corresponding to the anterior recorded infrared signal.

13. A non-transitory storage medium having stored thereon instructions that, when executed by a processor of a mobile device, wherein the method comprises:
determining, at the mobile device, a selected virtual key;
acquiring, at the mobile device, an identification number of the selected virtual key;
in response to detecting infrared signals sent from a remote controller to an electronic device, controlling, at the mobile device, the infrared module to record the infrared signals of one or more keys on the remote controller in sequence;
storing, at the mobile device, the recorded infrared signals to a queue corresponding to the identification number of the selected virtual key in sequence; and
setting, at the mobile device, an induction delay time corresponding to each of the recorded infrared signals in the queue.

14. The non-transitory storage medium according to claim 13, wherein the method further comprises receiving, at the mobile device, updated information of properties of the selected virtual key.

15. The non-transitory storage medium according to claim 14, wherein the properties of the selected virtual key comprise a shape, a size, a name of the selected virtual key, and a position where the selected virtual key located on a virtual remote controller.

16. The non-transitory storage medium according to claim 13, wherein the method further comprises:
deleting, at the mobile device, one of the recorded infrared signals from the queue when the recorded infrared signal is selected on a display device of the mobile device and a deletion option is triggered.

17. The non-transitory storage medium according to claim 13, wherein the method further comprises:
when the selected virtual key is triggered, transmitting, from the mobile device, the recorded infrared signals in the queue corresponding to the selected virtual key, to the electronic device in sequence.

18. The non-transitory storage medium according to claim 17, wherein the method further comprises:
when an anterior recorded infrared signal is sent to the electronic device, transmitting, from the mobile device, a posterior recorded infrared signal to the electronic device after induction delay time corresponding to the anterior recorded infrared signal.
